(19) United States
(12) Patent Application Publication
(10) Pub. No.: US 2012/0084958 A1
(43) Pub. Date: Apr. 12, 2012

(54) METHOD FOR REDUCING THE DIAMETER OF AN OPENING

(75) Inventor: Jean-Michel Serge Marcel Duret, Bondoufle (FR)

(73) Assignee: SNECMA, Paris (FR)

(21) Appl. No.: 13/375,318

(22) PCT Filed: Jun. 3, 2010
(86) PCT No.: PCT/EP2010/057787

§ 371 Date: Nov. 30, 2011

(30) Foreign Application Priority Data
Jun. 12, 2009 (FR) 0953950

(51) Int. Cl. B21J 5/00; B23P 6/00

(52) U.S. Cl. 29/402.19; 72/377

(57) ABSTRACT

A method for reducing the diameter of an opening, including peening a perimeter of the opening. A method for correcting the permeability of a part including a plurality of openings for allowing a gaseous fluid to pass therethrough. The method identifies at least one opening with a diameter which exceeds a predetermined upper limit and reduces the excessive diameter by peening a perimeter of the opening.

The present invention relates to a method for reducing the diameter of an opening.

The drilling of openings, in particular by machining, has particular tolerance problems. Whereas an insufficient diameter can be corrected by the component being re-machined, it is not possible to recover material lost when the opening reaches an excessive diameter. For this reason, such components are normally damaged beyond repair and are scrapped, thereby incurring costs.

A first object of the present application is therefore to provide a method for reducing the diameter of an opening, said method making it possible to recover components in which the diameter of at least one opening is greater than the required tolerances.

The method of the invention comprises a step of peening a perimeter of the opening. By peening a perimeter of the opening, a part of the material of the perimeter is pushed back toward the interior of the opening, reducing the diameter of the latter.

Advantageously, said peening can be carried out with a tool centered over the opening. In this way, it is possible to obtain a regular reduction in the diameter over the entire perimeter of the opening, thereby maintaining the initial shape of the opening.

Advantageously, a contact end of said tool may comprise an approximately spherical ball. The use of such a ball for peening allows a substantial reduction in the diameter of the opening with minimal impact on the surface that comes into contact with the ball along the perimeter of the opening.

However, the contact end of said tool may have other shapes, such as, for example, an approximately frustoconical shape.

Advantageously, said perimeter of the opening may be metallic. A metallic material has a certain malleability that allows, within certain limits, the plastic deformation of the perimeter of the opening.

More particularly, said perimeter of the opening may be composed of a refractory alloy, such as, for example, a nickel-based alloy, such as Inconel® 718 or Hastelloy® X, a cobalt-based alloy, such as MAR M 509, or a nickel/iron-based alloy. Such refractory alloys have a high cost and are difficult to machine. The normal scrappage rate is thus high, as are the resultant costs. The application of the method of the invention to components composed of a refractory alloy therefore becomes all the more advantageous.

The problem of the tight tolerances of variation in the diameter of the openings occurs particularly in the case of components comprising a plurality of openings of small diameter for a gaseous fluid to pass through. Such components usually have to have a predetermined permeability to said gaseous fluid. Although a permeability which is too low can be corrected by enlarging the through-openings for the gas, a permeability which is too high is not easy to correct and normally results in the components being scrapped.

A second object of the present application is thus to provide a method for correcting the permeability of a component comprising a plurality of through-openings for gaseous fluid.

A method for correcting permeability according to the invention comprises the steps of identifying at least one opening, the diameter of which exceeds a predetermined upper limit, and of reducing this diameter by the abovementioned method for reducing the diameter.

Advantageously, said correction method can also comprise a prior step of checking the permeability of the component. Thus, the permeability is only corrected beyond a predetermined maximum threshold.

Said openings may be cooling openings. Such openings generally have small diameters, but also have limited manufacturing tolerances. Furthermore, in order to maintain a certain temperature profile over the component, they are distributed over the latter with very strict positioning constraints. Thus, it is not normally possible to correct excessive permeability of such a component by simply filling in some of the cooling holes.

Another object of the present invention is to limit scrappage and the production costs of gas turbines, including turbojet engines, turboprop engines, turbine engines, etc. Said component may be a component of the hot section and/or the combustion chamber, for example a combustion chamber bowl or a combustion chamber base.

Details relating to the invention are described hereinbelow with reference to the drawings.

FIG. 1 shows a schematic view of an opening before a method for reducing the diameter according to one embodiment of the invention is applied thereto;

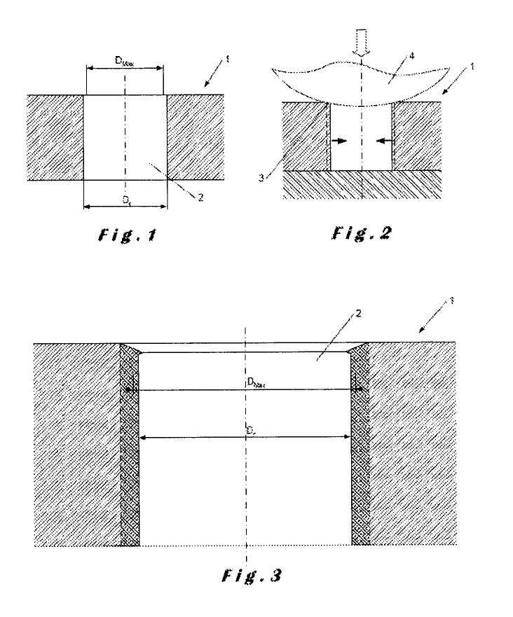

FIG. 2 shows a schematic view of the step of peening the perimeter of the opening from FIG. 1 in the method for reducing the diameter according to one embodiment of the invention;

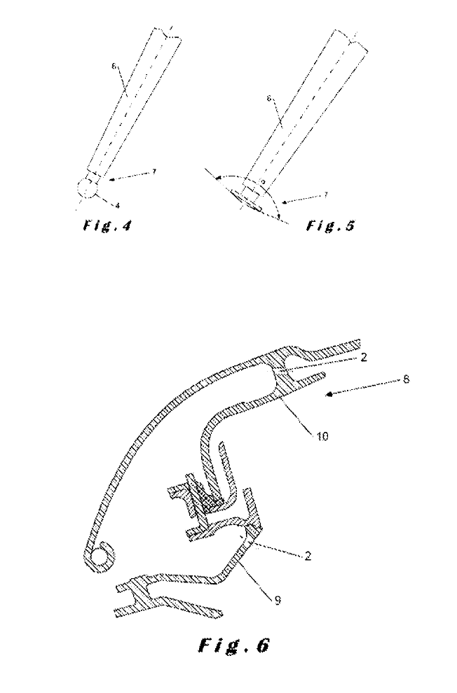

FIG. 3 shows a schematic view of the opening from FIG. 1 after the method for reducing the diameter according to one embodiment of the invention has been applied thereto;

FIG. 4a shows a view of a peening tool for the method for reducing the diameter according to one embodiment of the invention;

FIG. 4b shows a view of an alternative peening tool for the method for reducing the diameter according to one embodiment of the invention; and

FIG. 5 shows a cross-sectional view of a gas turbine combustion chamber having two cooling openings which can be treated by the method for reducing the diameter according to one embodiment of the invention.

In FIG. 1, an illustrated wall 1 has an opening 2, the actual diameter Dᵣ of which is greater, by up to 106, than a desired maximum diameter Dₘₐₓ. In one embodiment, which is illustrated in FIG. 2, of the method for reducing the diameter according to the invention, the perimeter 3 of the opening 2 is peened with a tool 6 comprising, at one contact end 7, a ball 4 having a diameter substantially greater, for example between 5 and 10 times greater, than the diameter Dᵣ of the opening 1. This tool 6 is illustrated in FIG. 4a. During the peening illustrated in FIG. 2, the ball 4 is centered over the axis A of the opening 2. In order to avoid bending deformation of the wall 1, the latter is supported on a substrate 5. Thus, the pressure of the ball 4 brings about plastic deformation of the entry perimeter 3 of the opening 2, causing the material to creep toward the interior of the opening 2. A bead toward the interior is thus formed. When peening has finished, as is illustrated in FIG. 3, the diameter of the opening 2 at its entry perimeter has decreased and is below the desired maximum diameter Dₘₐₓ. At the same time, the mechanical and thermal properties of the wall 1 are affected little, such that it is possible to use the wall 1 in the manner for which it is designed.

Although, in the peening step illustrated in FIG. 2, the peening tool 6 has a spherical or approximately spherical ball 4 at its end, other shapes can be used. For example, the tool 6 could have at its end a frustoconical contact end 7, as is illustrated in FIG. 4b. Preferably, the cone angle α would be greater than 120°. More particularly, it would be greater than 150°.

Although, in the embodiment illustrated, the tool 6 is aligned with the axis of the opening 2, the method of the invention can also be applied to openings which have an angle with the peening pressure. This angle may be, for example, 30°, or less than 30°, preferably less than 20°.

The method of the invention is particularly useful for correcting excessive permeability of components having openings for cooling by the passage of a gaseous fluid, such as air. In particular, the method of the invention may be useful for correcting excessive permeability of components of the hot section of a gas turbine, for example a bowl, a film or a base of the combustion chamber. FIG. 5 illustrates a detail of a combustion chamber 8 in such a gas turbine hot section. This combustion chamber 8 comprises a bowl 9 and a film 10 which have cooling openings 2. Such components of a gas turbine hot section are generally produced from refractory alloy, such as Inconel® 718, Hastelloy® X or MAR M 509. The openings 2 are drilled by known machining techniques, such as laser machining. It is thus normally difficult to correct excessive permeability following machining. The method of the invention may be employed to correct excessive permeability of these components by reducing the diameter of some of its cooling openings 2.

For this purpose, in a first step, the permeability of the component 8 or 9 is checked. If it exceeds a maximum threshold, the openings 2 are individually measured in order to identify the ones that exceed a maximum diameter Dₘₐₓ. Next, the latter openings 2 are treated by the method for reducing the diameter described hereinabove, in order to reduce the permeability of the component and to come back into the tolerance range.

The refractory alloys used in such components also have increased hardness. High peening forces will thus normally be required. Table 1, below, reproduces examples of peening such openings in walls composed of refractory alloy:

TABLE 1
Examples of peening

| | | | Force |
|---|---|---|---|
| Ø Before | Ø After | Reduction | [Kp] |
| 0.9 | 0.83 | 0.07 | 500 |
| 0.9 | 0.82 | 0.08 | 300 |
| 0.9 | 0.86 | 0.04 | 200 |
| 1.14 | 1.04 | 0.1 | 500 |
| 1.13 | 1.03 | 0.1 | 450 |
| 1.15 | 1.07 | 0.08 | 400 |
| 1.14 | 1.09 | 0.05 | 300 |
| 1.14 | 1.11 | 0.03 | 200 |
| 1.12 | 1.09 | 0.03 | 150 |
| 1.2 | 1.13 | 0.07 | 450 |
| 1.19 | 1.1 | 0.09 | 400 |
| 1.2 | 1.15 | 0.05 | 300 |
| 1.18 | 1.12 | 0.06 | 200 |
| 1.19 | 1.18 | 0.01 | 150 |
| 1.39 | 1.26 | 0.13 | 650 |
| 1.41 | 1.31 | 0.1 | 600 |
| 1.42 | 1.35 | 0.07 | 500 |
| 1.42 | 1.38 | 0.04 | 400 |
| 1.43 | 1.39 | 0.04 | 300 |
| 1.43 | 1.4 | 0.03 | 250 |

By virtue of the method according to the invention, it is thus possible to recover components which would otherwise have been destined for scrap.

Although the present invention has been described with reference to specific exemplary embodiments, it is clear that various modifications and alterations can be made to these examples without departing from the overall scope of the invention as defined by the claims. Therefore, the description and the drawings should be considered to be illustrative.

1-11. (canceled)

12. A method for reducing a diameter of an opening, comprising:
peening a perimeter of the opening by a tool, a contact end of which is spherical or approximately spherical or frustoconical.

13. The method as claimed in claim 12, in which the peening is carried out with a tool centered over the opening.

14. The method as claimed in claim 13, in which a contact end of the tool comprises a ball.

15. The method as claimed in claim 12, in which the perimeter of the opening is metallic.

16. The method as claimed in claim 12, in which the perimeter of the opening is composed of a refractory alloy.

17. The method as claimed in claim 12, in which the diameter of the opening is between 0.5 and 3 mm.

18. A method for correcting permeability of a component including a plurality of through-openings for gaseous fluid, the method comprising:
identifying at least one opening, the diameter of which exceeds a predetermined upper limit; and
reducing the excessive diameter by a method as claimed in claim 12.

19. The method as claimed in claim 18, further comprising a prior operation of checking permeability of the component.

20. The method as claimed in claim 18, in which the openings are cooling openings.

21. The method as claimed in claim 18, in which the component is part of a gas turbine hot section.

22. The method as claimed in claim 18, in which the component is part of a combustion chamber.
